(19) United States
(12) Patent Application Publication
(10) Pub. No.: US 2025/0179747 A1
(43) Pub. Date: Jun. 5, 2025

(54) Ground Support Equipment (GSE) Baggage Cart Foreign Object Debris (FOD) Removal Sweeping Mechanism

(71) Applicant: Ryland Brickner-McDonald, Mountain Lakes, NJ (US)

(72) Inventor: Ryland Brickner-McDonald, Mountain Lakes, NJ (US)

(21) Appl. No.: 18/527,273

(22) Filed: Dec. 2, 2023

(51) Int. Cl. E01H 1/04; B64F 1/36

(52) U.S. Cl. CPC E01H 1/047; B64F 1/36

(57) ABSTRACT

A computer-enhanced mechanical sweeping mechanism removably affixed to existing ground service equipment (GSE) for the collection and removal of foreign object debris (FOD) in a removable hopper. Movement of a GSE vehicle rotates the independently suspended drive wheels, transmitted by 3 gears/pulleys and chain/belts to power a cylindrical bristle, spinning in the opposite direction of travel, to collect and funnel FOD via a ramp into a removable hopper. Bristle height is adjustable. At least one magnet and skid plate remove metallic FOD. Enabled with detectors and warning light.

### CROSS-REFERENCE

None.

### FIELD OF THE INVENTION

This invention relates to a mechanical or stationary mechanism to collect debris from hard surfaces. Particularly, this invention relates to retrofitting and attaching a mechanical or stationary mechanism to an existing vehicle to collect debris from hard surfaces.

### BACKGROUND ART

As evidenced by various United States Department of Transportation Federal Aviation Administration advisory circular (such as AC No: 150/5210-24) Airport Foreign Object Debris (FOD) management is of concern. FOD is any object, live or not, located in an inappropriate location in the airport environment that has the capacity to injure airport or air carrier personnel and damage aircraft. FOD management is composed of four main areas: prevention; detection; removal; and evaluation.

The present invention promotes the detection and removal of FOD. More specifically, the present invention discloses FOD detection equipment and FOD removal equipment.

The presence of FOD on an airport's air operations area may pose a threat to the safety of air travel. FOD has the potential to damage aircraft during critical phases of flight and may lead to life threating injuries and property damage as well as increased maintenance and operating costs. FOD related hazards may be ameliorated by FOD detection and removal equipment.

Recent technological developments have greatly expanded the capabilities of FOD detection through automation. New FOD removal equipment is either mechanical (sweeper) and non-mechanical (magnetic bars and sweeping mats) to replace FOD removal equipment such as rumble strips (also known as “FOD Shakers”).

One drawback of most of such technology is the requirement for new expensive equipment. Another drawback is the need for training in the use of said new equipment. A third, drawback of existing FOD detection and removal equipment is that while magnetic bars can be suspended beneath tugs and trucks pick up metallic material, they need to be cleaned regularly to prevent them from dropping the collected debris. Additionally, said magnetic bar can only remove magnetic materials while leaving FOD made of ceramic, rare earth, alnico metals, titanium and aluminum alloys, some stainless steels, and plastics.

At airports, research shows foreign object debris (FOD) can be highly detrimental to aircraft ground operations. FOD is any unwanted piece of material-steel, plastic, asphalt, passenger item-on an airside pavement surface (tarmac) at airports that could potentially damage an aircraft and/or ground vehicles. Runway FOD includes various objects, more specifically parts fallen from aircraft or vehicles, broken ground equipment, birds, among others that are present on a runway that may adversely affect fast-moving aircraft.

Sweeping is required to remove FOD. It may be done manually (which is prohibitable expensive) or with the airfield sweeper, which is the most effective equipment for removing FOD from airside surfaces. The sweeper removes debris from cracks and pavement joints, and should be used in all areas except for those that can be reached only with a hand broom.

Costs related to failures to remove FOD can be very expensive. Airlines spend millions of dollars every year in direct (damage to aircraft) and indirect (flight delays) damages. To combat FOD, there are many airfield sweepers on the current market that collect FOD effectively; however, they all have one drawback in common. To collect the debris, current products rely on an additional tow vehicle thus requiring additional energy and logistics, including additional airside ground vehicle movements and personnel to operate said vehicles.

In the prior art, a sweeper attachment for a refuse collection vehicle that utilizes either a conveyor system or a vacuum system to transport debris from a road surface to a collection body of the refuse collection vehicle has been disclosed. Consider U.S. Pat. No. 4,069,929 to Harker Jan. 24, 1978 (Mechanism for compacting material), or 2013/0322994 (Front-Loadable Refuse Container Having Side-Loading Robotic Arm with Motors And Other Mass Mounted At Rear Of Container And Use Of Same With Front-Loading Waste-Hauling Vehicle Having Hydraulic Front Forks Or Other Retractably Engageable Lift Means), among others. Additionally, a sweeper attachment which allows for the same vehicle to be used for two purposes including sweeping roadway surfaces has been disclosed by prior art. Consider U.S. Pat. No. 10,815,629 Goedken, et al. Oct. 27, 2020.

A typical adjusting vertical suspension is configured as disclosed in U.S. Pat. No. 3,371,940 Patented Mar. 5, 1968 VEHICLE VARIABLE HEIGHT SUSPENSION SYSTEMS by Alex H. Sinclair, et al.

There is a need for an improved FOD collection method that does not require additional energy, personnel, and logistics. The present invention could be implemented to address this problem and may be employed in non-airport settings.

### Novel Structural Element and Related Advantages of the Present Invention

While both ideas of attaching a sweeping mechanism to an existing vehicle are similar, the idea that makes the present invention unique compared to the garbage truck sweeper for example relates to both the structure that attaches to an existing vehicle and to other advantages. More specifically, the present invention discloses a support structure that can be attached and removed from the underside of an existing vehicle in between the front and rear axles, such as an airport ground support equipment (GSE). Airport GSE is used to service airplanes between flights. Services include refueling, towing airplanes or luggage/freight carts, loading luggage/freight, transporting passengers, loading potable water, removing sewage, loading food, de-icing airplanes, and firefighting. The present invention, which may be retrofitted to GSE is capable of removing foreign object debris (FOD) from planar surfaces such as airside surfaces.

With solely this support structure a sweeping mechanism is not designed to be attached communicating with GSE Baggage Carts. An advantage of the present invention is the capability transforming baggage carts into cleaning machines. The present invention incorporates a combination of track rollers and linear rails to allow the dynamical reconfiguration of the sweeping mechanism, thus surmounting the shortcomings of the prior art, namely static positioning of sweeping elements.

The prior art requires a permanent communication between a sweeping element and the GSE vehicle, thus limiting said GSE to a particular function, or the cleaning element to a particular GSE. The present invention overcomes this shortcoming by employing tabs. The advantage of tabs lies in that it enables the present invention to be moved for use from one GSE to another. The benefit of this feature is that the present invention may be moved from GSE to GSE as said GSEs require maintenance.

Novel structural equipment is needed, namely the cart like structure that rides along the support structure. The cart like structure enables a sweeping mechanism to attach. A turntable that is a part of the cart like structure provides 360° movement for the sweeping mechanism, attached below. Direction of travel of the existing vehicle will not cause damage to either the vehicle or sweeping mechanism.

The cart like structure also contains track rollers that enable the entire assembly (the cart like structure and sweeping mechanism) to move linearly back and forth along the horizontal support structure. This allows for specific placement of the entire assembly anywhere along the support structure. In this case, allowing the entire assembly to be accessible outside the confines of a tight space under an existing vehicle (GSE Baggage Cart). Once assembled, the sweeping mechanism attached to the cart like structure can be moved from the edge of an existing vehicle to any location along the support structure. In this case, to the center of a GSE Baggage Cart. This also allows for removal and disposal of the collected debris without the need to go under an existing vehicle as all access to the sweeping mechanism is done from the side of the existing vehicle.

The present invention ameliorates the cost of implementing FOD detection and removal technologies by retrofitting baggage carts with FOD detection and removal technologies. The present invention discloses imaging technology integrated with artificial intelligence which communicates with automatic alert systems.

In short, this invention is unique when compared to the garbage truck sweeper due to the cart like structure that rides along the support structure 38 (the structure attached to an existing vehicle). The cart like structure allows the connected sweeping mechanism to rotate 360° as well as move linearly as one unit along the support structure 38. This combination of movement allows all interactions between worker and sweeping mechanism to be performed at the edge of the existing vehicle rather than underneath it.

### BRIEF SUMMARY OF THE INVENTION

The mechanical or stationary mechanism to collect debris from hard surfaces is unique compared to existing systems because an extra vehicle is not needed; instead, a support structure attached under pre-existing vehicles, such as a GSE Baggage Cart, between the front and rear axles. A cart-like structure rides along the support structure and a mechanical or stationary mechanism can be attached and removed from this cart-like structure.

The primary design goals considered when developing the support structure 38 and cart like structures include: 1. attachment and removal from a pre-existing vehicle, 2. linear movement of the attached mechanical or stationary mechanism, 3. 360° rotational movement of the attached mechanical or stationary mechanism. Ultimately, the installation of the support structure 38, and associated cart like structure, gives any pre-existing vehicle a dual purpose; specifically, GSE baggage carts will now have the ability to transport passenger's luggage as well as clean FOD from tarmacs. The support structure 38 and cart like structures has been designed and prototyped with input from industry experts and has been designed and tested on an existing GSE Baggage Carts. The support structure is attached to the underside of the H or I frame of a pre-existing GSE Baggage Cart, between the front and rear axles, and can be attached and removed with nuts and bolts. The cart like structure, upon which the mechanical or stationary mechanism is attached, rides along the support structure 38. The support structure 38 and cart like structures could also be used to retrofit any pre-existing vehicle, giving any vehicle a dual purpose, including fields other than aviation.

### Advantages Over the Previous Provisional Patent Application

This provisional patent application has been improved in a number of ways compared to the prior art.

The present invention discloses a support structure 38 and cart like structures used to attach a mechanical or stationary mechanism to a GSE Baggage Cart. The two major aspects of the newly designed support structure 38 and cart like structures are the ability for the cart like structure to ride linearly along the support structure 38. This allows accessibility to the mechanical or stationary mechanism at the edge of a GSE Baggage Cart to remove collected debris from the collection hopper. The other major aspect is the ability for the mechanical or stationary mechanism to rotate 360° about the cart like structure. In short, the support structure 38 and cart like structures are the enabling medium allowing the mechanical or stationary mechanism to operate under a GSE Baggage Cart.

In addition, the mechanical or stationary mechanism attached to the cart like structure, riding along the support structure 38, has improvements. Most significantly, a suspension system has been added to the mechanical mechanism to ensure the drive wheels that power the mechanical mechanism are in constant contact with the ground. More so, additional gearing allows a bristle system to spin opposite of the drive wheels. The collection hopper's design has also improved for easy access when removing collected debris and the addition of a magnet for collection of metallic objects.

### BRIEF DESCRIPTION OF THE DRAWINGS

The support structure is designed and fabricated with steel components including: linear rails and linear rail cross members with tabs to allow attachment to an existing vehicle. The cart like structure that rides along the support structure 38 is designed and fabricated with steel components including: linear rail track rollers, steel plates, solid surface rectangular turntable, and hitch receiver. All components for both structures are welded and/or connected with nuts and bolts.

FIG. 1 is a side view of the total cart assembly.

FIG. 1A is a top view of the total cart assembly.

FIG. 1B is a front view of the total cart assembly.

FIG. 1C is a side view of the support structure.

FIG. 1D is a top view of the support structure.

FIG. 1E is a front view of the support structure.

FIG. 1F is a side view of the communication element.

FIG. 1G is a top view of the communication element.

FIG. 1H is a front view of the communication element.

FIG. 1I shows a side view of the combined total cart assembly in relation to the support structure.

FIG. 2 is the top view of the support structure and total cart assembly.

FIG. 2A is the front view of the support structure and total cart assembly.

FIG. 2B is a side of the support structure, total cart assembly, and communication element (showing a combination of FIGS. 1, 1C, and IF).

FIG. 2C is a top view of the components disclosed in FIG. 2B.

FIG. 3 is a front view of the support structure, total cart assembly, and the communication element allowing the linear rail and associated cart-like structure to attach to existing GSE.

FIG. 3A is a side view of the components disclosed in FIG. 2B when attached to an existing GSE.

FIG. 3B is the top view of the components disclosed in FIG. 3A.

FIG. 3C is the front view of the components disclosed in FIG. 3A.

FIG. 4 is the side view of the sweeping mechanism.

FIG. 5 is the top view of the sweeping mechanism.

FIG. 6 is the side view of the sweeping mechanism and the assembly of the communication element, support structure, and total cart assembly.

FIG. 7 is a top view of FIG. 6.

FIG. 7A is a side view of the existing GSE, the GSE wheel and axle, sweeping mechanism, assembly of communication element, support structure, and total cart assembly.

FIG. 7B is a top view of FIG. 7A.

FIG. 8 depicts a sample IR receiving circuit used in an embodiment of the invention.

### DETAILED DESCRIPTION OF THE INVENTION

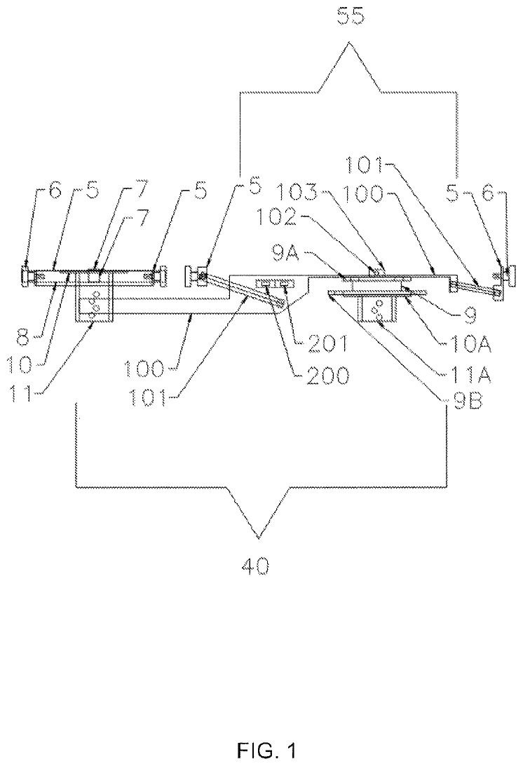

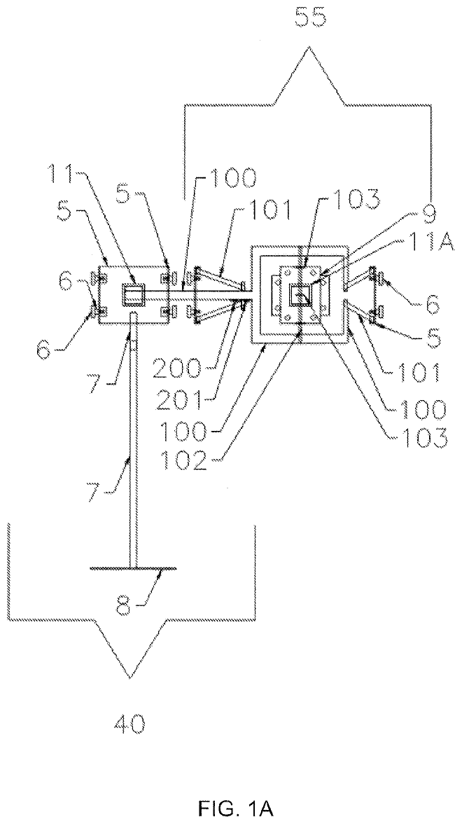

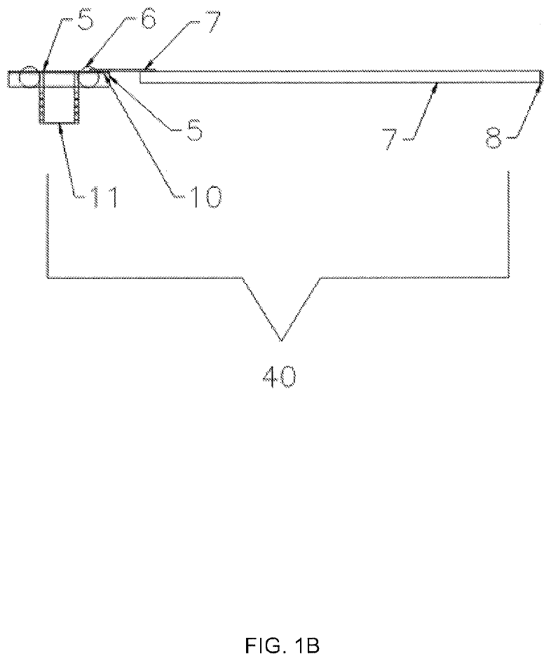

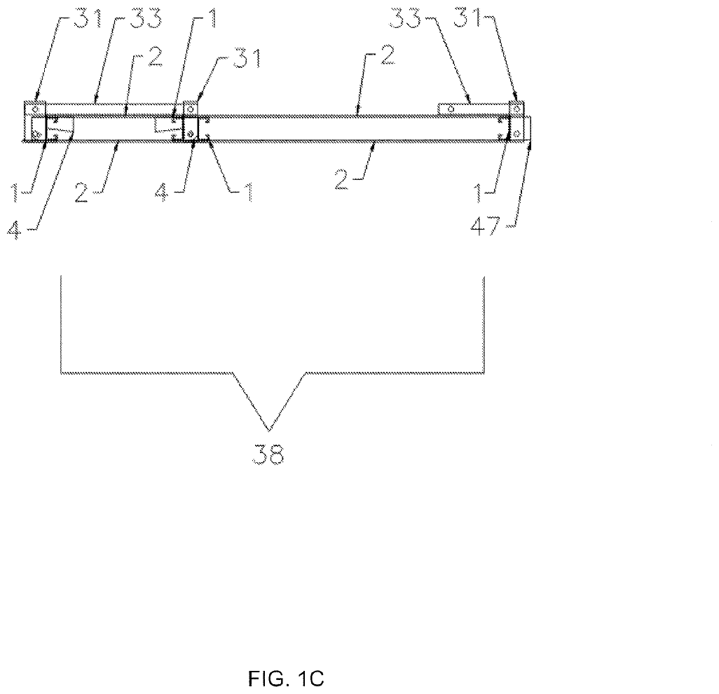

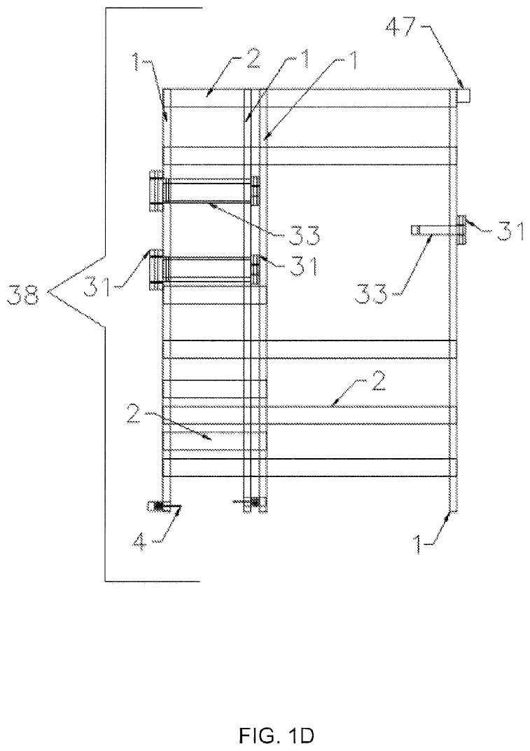

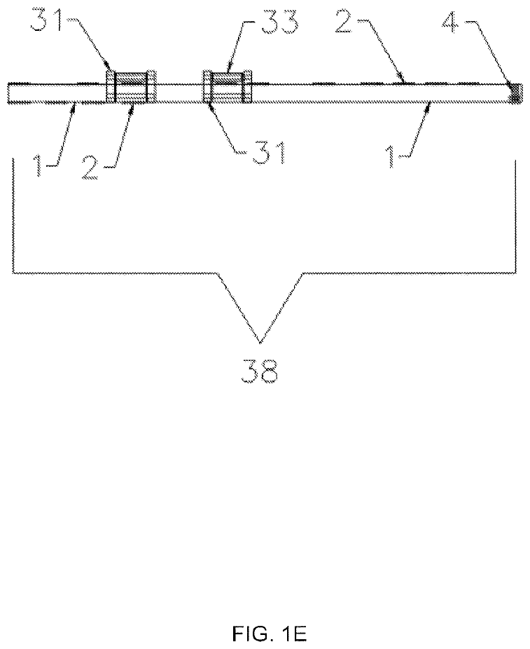

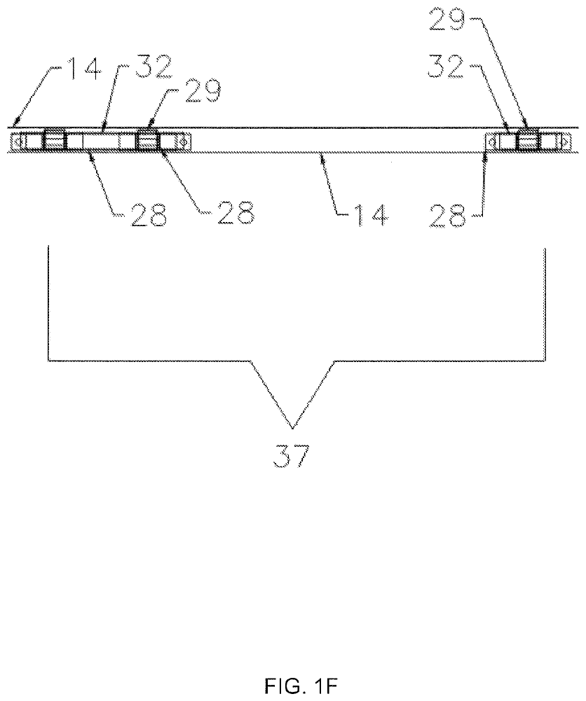

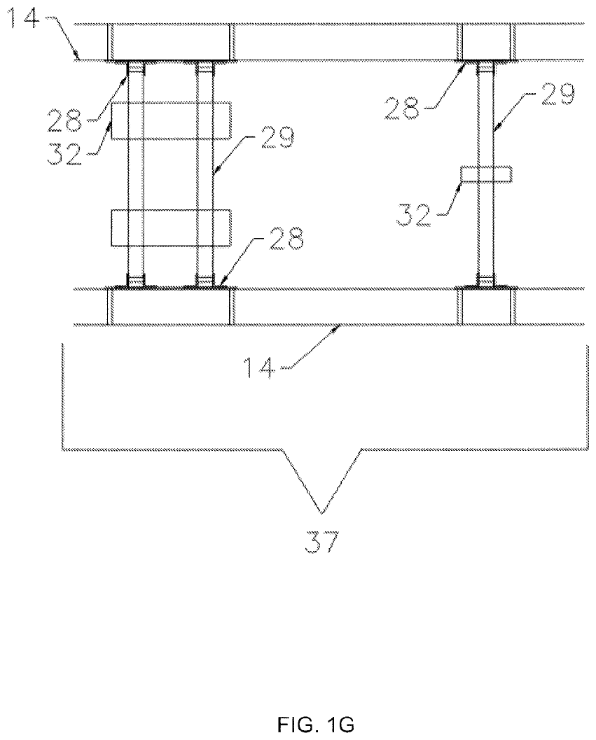

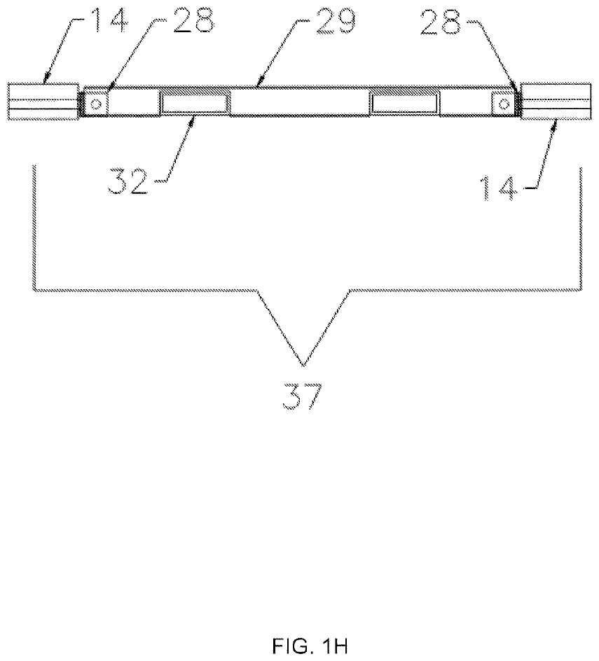

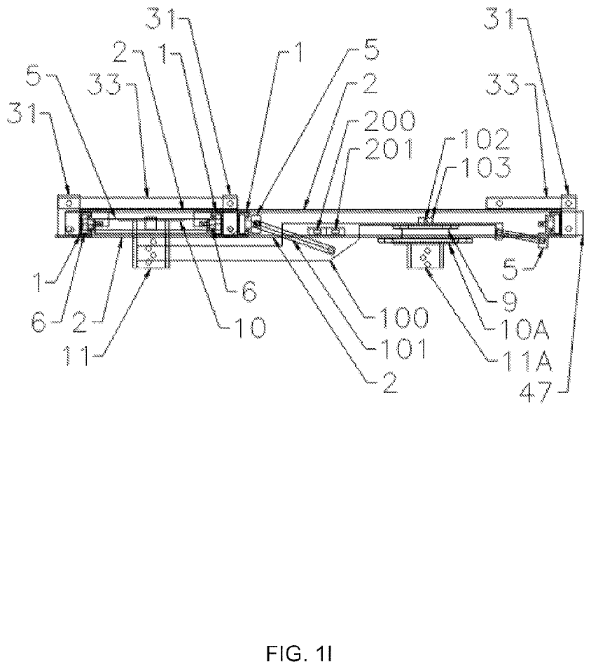

FIGS. 1, 1A, and 1B depict the total cart assembly 40, comprised of cart 5, track rollers 6, rigid rod 7, rigid plate 8, turntable 9, rigid sheet 10, and hitch receiver 11.

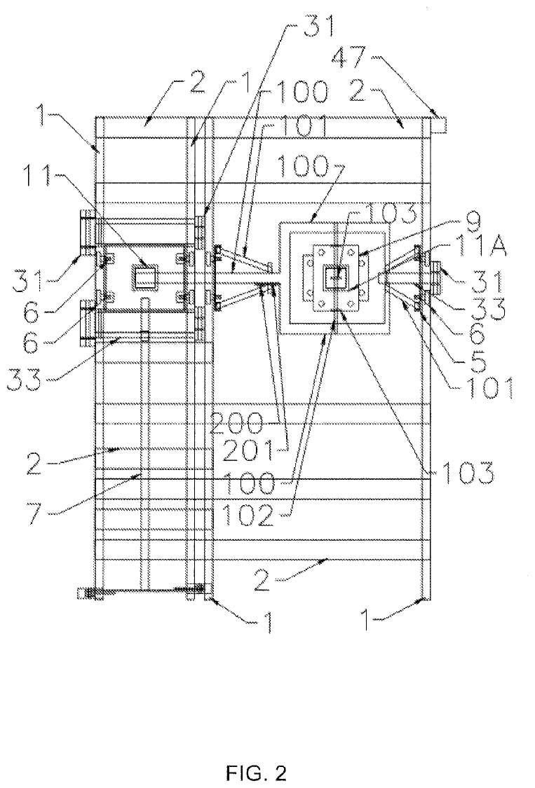

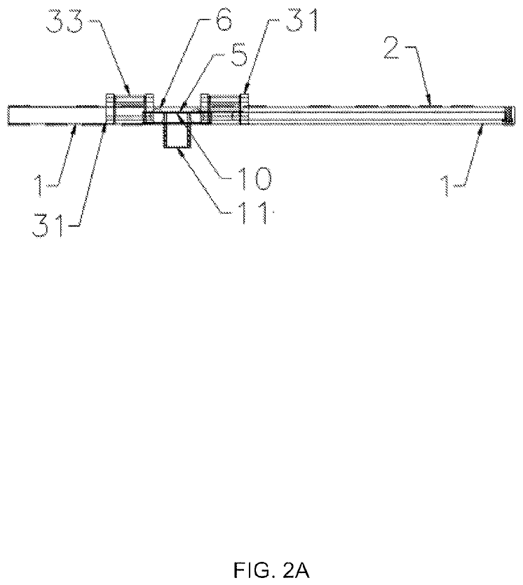

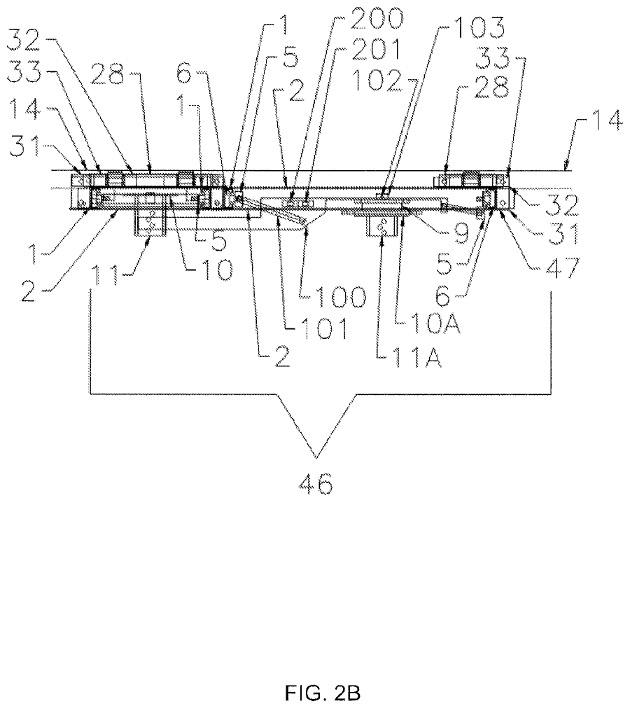

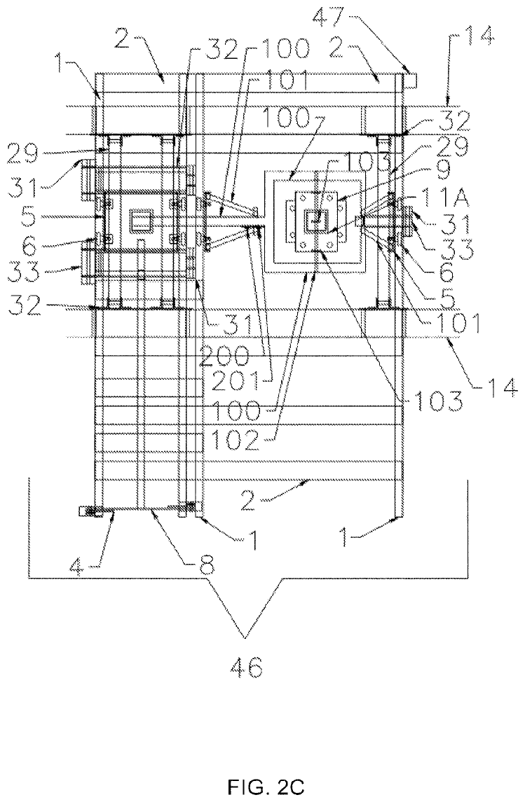

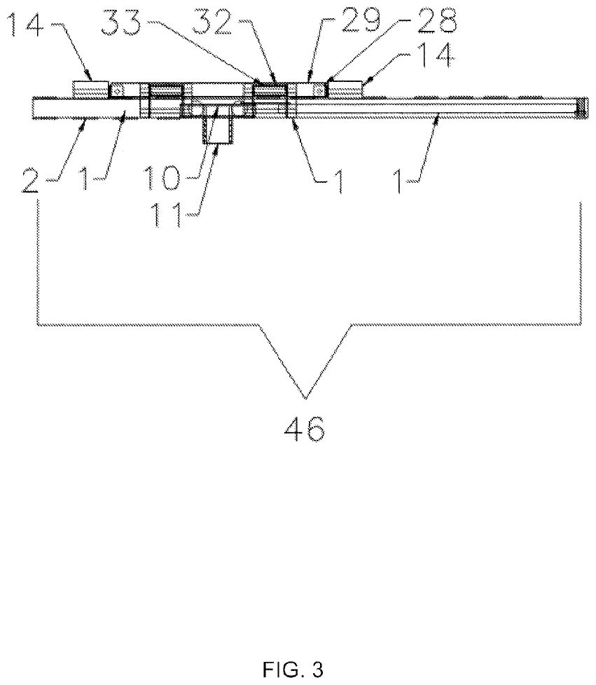

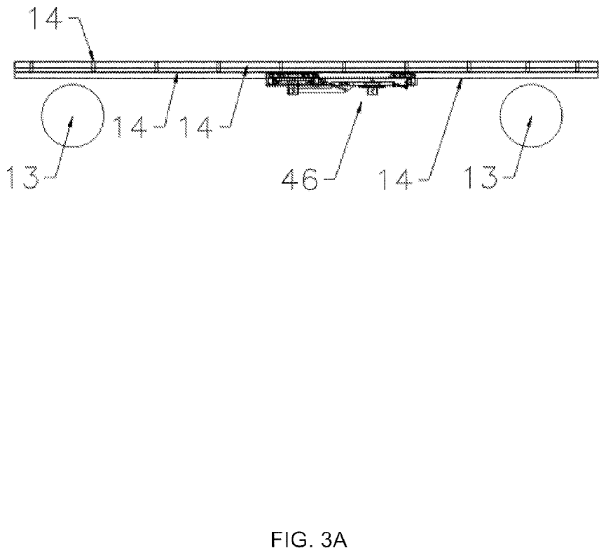

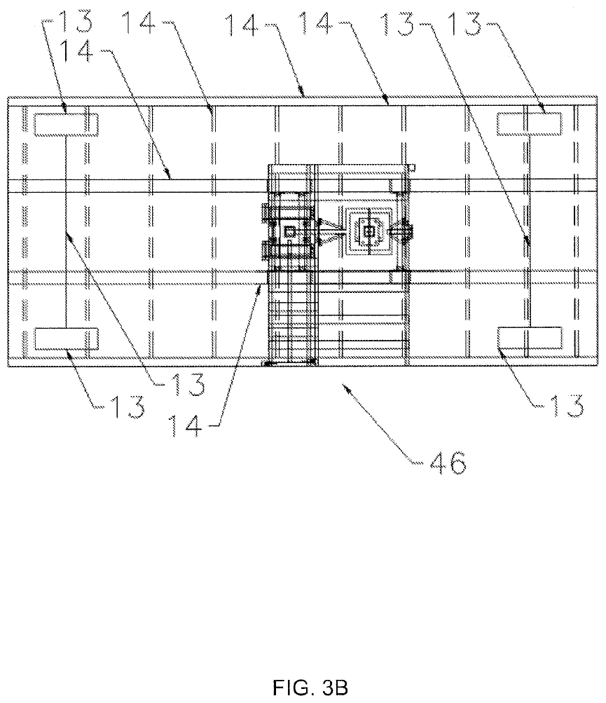

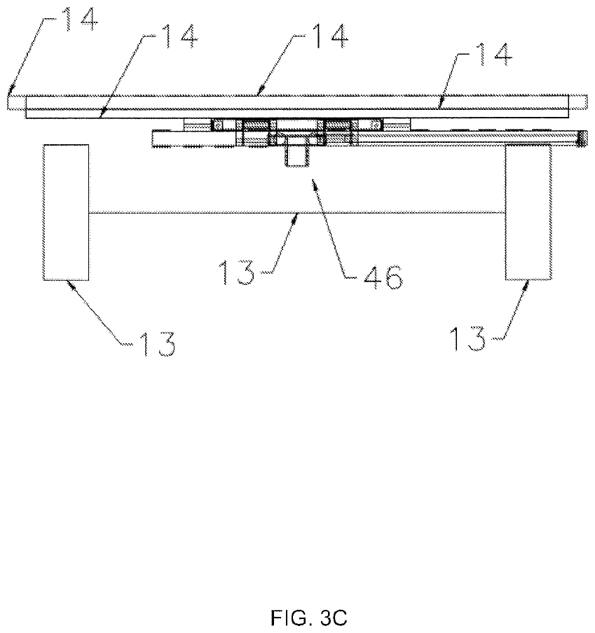

FIGS. 1, 2, and 3, wherein FIGS. 2 and 3 show linear rails 1, two (2) rigid linear rails 1 are aligned parallel to one another and perpendicular to rectangular rigid plate cross members 2 that are in communication above and below rails 1 creating a solid structure. In an alternative embodiment, steel L-brackets (not shown) may be used to replace the communication element 37.

Also disclosed in FIG. 1 is an accelerometer 200 attached to trailing arm 100. It is adapted to determine when spring attachment 101 breaks. Accelerometer 200 is in communication with communication accelerometer adapter 201. The accelerometer Communication accelerometer adapter 201 communicates with computer 47. When computer 47 receives a signal from communication accelerometer adapter 201, computer 47 signals indicator light (not shown) to illuminate. Said light is disposed such as to be readily visible to a GSE tug operator and adapted to communicate with and respond to signals from computer 47.

In a preferred embodiment, said light is resettable and can differentiate between inputs such that said operator can determine which condition described herein is triggering illumination. For example, if the brush of the cylindrical bristle sweeper 19 has shortened too much as indicated by weight sensor 54, a blinking illumination associated with such condition would indicate said brush should be lowered by a quarter of an inch. If illumination is solid, the operator is notified that the cylindrical bristle sweeper mechanism 19 should be replaced. In still other embodiments said light may be color coded communicating different operating instructions for specific colors such as red meaning to stop the GSE for uncollected debris as signaled to computer 47 from first camera 51 and second camera 52; a blue indicator may indicate a need to replace drive wheels from information collected by height sensor 53.

FIG. 1 further depicts a variable height suspension assembly 55 comprising elements cart-like structure 5, track rollers 6, turntable top element 9A and turntable bottom element 9B, second rigid sheet 10A, second hitch receiver 11A, trailing arm assembly 100 attached to spring attachment 101, pivot shaft 102, turntable plate 103, accelerometer on trailing arm 200, and communication accelerometer adapter 201.

Now referring to FIGS. 1, 1A, and 1B, the present invention is a continuation-in-part differing from the disclosure of U.S. Pat. No. 11,840,813 in that turntable 9 is relocated from the front end of the total cart assembly 40 to the rear end of the total cart assembly 40. Additionally, a second rigid sheet 10A and hitch receiver 11A are disposed upon the rear end of the total cart assembly 40.

FIG. 2 and FIG. 3 show a system of male tab 33 and female tabs 32 that may be used to provide structural support by a female tab 32 being affixed to the GSE which, in turn, may be affixed to linear rail 1. FIG. 3A, FIG. 3B, and FIG. 3C show the support structure, total cart assembly, and communication element affixed to a GSE vehicle. As disclosed in FIG. 1A, the present invention has four spring attachment 101 elements communicating with trailing arm 100. A leading end of spring attachment 101 is affixed to cart 5 and trailing end of spring attachment 101 is attached to trailing arm 100 for each said spring attachment 101. If spring attachment 101 is broken or vibrates excessively, it will activate the trailing-arm accelerometer 200, said accelerometer 200 being adapted to send a third signal the communications accelerometer adapter 201. Said accelerometer is adapted to send said third signal when acceleration is greater than approximately four feet per second per second (per second²). Said communications accelerometer adapter 201 then sends a fourth signal to computer 47. Computer 47 then sends a fifth signal to illuminate the light 48 visible to the GSE tug driver.

The present invention's removability capability feature results from 37 the use of tabs (insertable rigid connectors). More particularly, male tabs 33 affix to the rigid tab support attachment 31 which in turn is attached to support structure 38. Whereas female tabs 32 are attached to communication element 37 which in turn is connected to the existing GSE structure 14. The use of tabs allows the present invention to remain in a relatively fixed position while in use while simultaneously allowing the present invention to be removed easily.

FIGS. 1C, 1D, and 1E show the support structure 38, and fixed supports for male tabs 33. Female tabs 32 and connection to GSE vehicle in relation are depicted in FIGS. 1F, 1G, and 1H. Additionally, FIG. 1F discloses the relative position of existing vehicle attachment (GSE baggage cart) 28, existing vehicle attachment (GSE baggage cart) cross-member 29, and female tabs 32 as disposed on existing GSE structure 14. Note that FIG. 1F calls out how the existing vehicle attachment (GSE baggage cart) 28 and existing vehicle attachment (GSE baggage cart) cross-member 29 support female tabs 32. FIG. 1G and FIG. 1H illustrate this relationship from other perspectives. In sum, the use of male tabs 33 and female tabs 32 result in the removability of sweeping mechanism 39.

Existing GSE structure 14 may be composed of parallel and perpendicular elements. The present invention may be attached in any orientation. Consequently, the present invention may be oriented either parallel or perpendicularly to the GSE's direction of movement. In the preferred embodiment, all elements of the present invention are located within the area defined by the footprint of the GSE vehicle. However, in an embodiment where GSE has only operational side, such as a single-door baggage hauler, the present invention may optionally beyond said confines.

Communication element 37 is in communication with support structure 38 via at least one female tab 32 and at least one male tab 33. Said male tab 33 is supported by a rigid tab support attachment 31 for affixing to support structure 38 linear rail tops of specific cross members, allowing attachment to an existing vehicle's structure. In addition, the open side of the support structure 38 contains two slightly staggered slits, one on each of the linear rails. The staggered slits are cut into the linear guide rails and rigid plate blockers are placed at both slit locations, limiting the movement of the cart like structure that rides along the rail system.

The present invention discloses a support structure 38 depicted in FIGS. 1C, and 1D. Said support structure 38 enables connection of female tabs 32 to the GSE vehicle as well as allowing cart-like structure 5 to move linearly along linear rails 1. Cart-like structure 5 in turn connects to a sweeping mechanism 39 disposed below cart-like structure 5. Said sweeping mechanism 39 may be dynamic or stationary.

The present invention discloses track rollers 6 as shown in FIGS. 1, 1A, 1B, 1I, 2, 2A, 2B, 2C, and 3, among other references. Said track rollers 6 communicate with cart-like structure 5 and linear rail 1. Said rollers 6 allow the cart-like structure 5 to move linearly along linear rails 1 for the purpose of permitting movement of the cart-like structure 5 to allow access to a collection hopper 24.

As depicted in FIGS. 2B and 2C, the present invention allows track roller 6/linear rail 1 the capability of dynamically reconfiguring the position of sweeping mechanism 39.

FIG. 1E discloses a front view of the support structure and relative positioning of linear rail cross-members 2, linear rail to existing GSE tab support 31, and linear rail to existing vehicle male tab attachment 33, and total cart plate blockers 4. A plurality of linear rail cross members 2 on the top of the linear rail 1, and at least one linear rail cross-member 2 on the bottom of linear rail 1. Said linear rails are necessary to fix in place said linear rail 1.

The present invention discloses rigid rod 7 in communication with cart-like structure 5 and rigid plate 8. Rigid rod 7 is capable of moving cart-like structure 5 forward and back along linear rail 1.

The present invention discloses rigid plate 8 in communication with rigid rod 7 and cart-like structure plate-blockers 4. Said rigid plate 8 is capable of restricting linear movement of cart-like structure 5 while in operation.

Also disclosed is at least one turntable 9. Said at least one turntable 9 is composed of a top element 9A and a bottom element 9B, which communicate by ball bearings (not shown) disposed therebetween. Said top element 9A communicates with cart-like structure 5. Said bottom element 9B communicates with second rigid sheet 10A. Second rigid sheet 10A is permanently affixed to second hitch receiver 11A. Turntable 9 is capable of 360 rotation permitting the sweeping mechanism to move freely without respect to the direction of movement of the external GSE. It should be noted original rigid sheet 10 is attached to cart-like structure 5, and hitch receiver 11 is attached to rigid sheet 10.

Now referring to FIG. 1C, computer 47 is attached to rigid rail 1. Said computer 47 communicates with an indicator light visible to GSE tug 48 driver, an infrared transmitter in hopper 49, a first camera 51, a second camera 52, a height sensor 53 on drive wheel axle 300 for drive wheels 16, a weight sensor 54 on spring 56 to ascertain both bristle wear and brush height on cylindrical bristle sweeper 19.

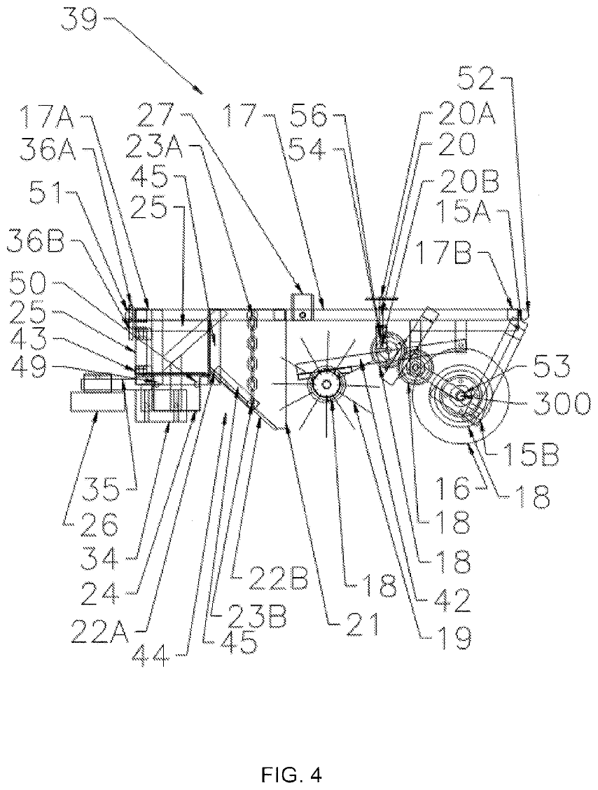

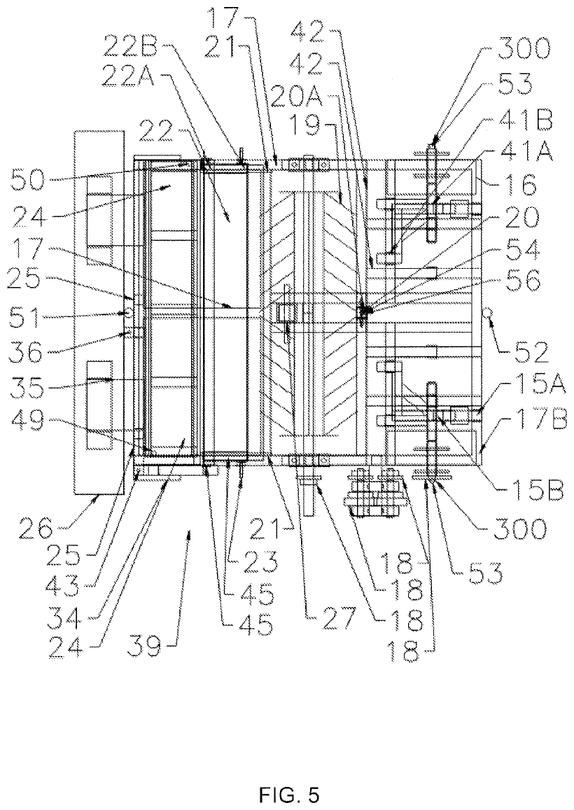

FIG. 4 and FIG. 5 depict side view and top view of the sweeping mechanism 39 disclosed by the present invention.

A sweeping mechanism 39 communicates with hitch receiver 11. Sweeping mechanism 39 is comprised of hitch shank 27 which communicates to mechanical sweeper frame 17. Mechanical sweeper frame 17 has a first end 17A and a second end 17B. Mechanical sweeper frame first end 17A communicates with shock absorber 15. Shock absorber 15 has a first end 15A and a second end 15B. More specifically, mechanical sweeper frame second end 17B communicates with shock absorber first end 15A. Said shock absorber second end 15B communicates with trailing arm 41 (shown in FIG. 5). Said trailing arm has a first end 41A affixed to drive wheel 16 and a second end 41B communicates with mechanical sweeper frame 17 (FIG. 5).

Mechanical sweeper frame first end 17A communicates with rotatable hooper arm 25. Rotatable hooper arm 25 via at least one pivot joint 43 making rotatable hopper arm 25 capable of movement. Said rotatable hopper arm 25 communicates with skid plate 34 and magnet support 35. Magnet support 35 supports magnet 26 as shown in FIG. 4. Skid plate 34 protects magnet 26 and collection hopper 24 from damage. Magnet 26 gives the invention the capability of retrieving ferrous material from the planar surface.

Additionally, sweeping mechanism 39 also has a spring-loaded pin hitch 36 which communicates with mechanical sweeper frame first end 17A as well as rotatable hopper arm 25. Generic gear/chain/belt assembly 18 communicates with drive wheel 16 as shown in FIGS. 4 and 5. Said gear/chain/belt assembly 18 communicates with cylindrical bristle sweeper 19 via a common belt or chain (not shown). Said spring hitch 36, while mounted on mechanical sweeper frame 17, extends through said mechanical sweeper frame 17 to communicate with rotatable hopper arm 25 as further shown in FIGS. 4 and 5. Said extension governs movement of rotatable hopper arm 25 allowing either static or dynamic positioning.

Said cylindrical bristle sweeper 19, gear/chain/belt assembly 18, and drive wheel 16 communicate with each other via a series of sprockets, gears and mesh. Said cylindrical bristle sweeper 19 is supported by bristle support arm 42. Said bristle support arm 42 communicates with a bristle height adjustment/jack screw 20 which, in turn, communicates with mechanical sweeper frame 17.

Still further, sweeping mechanism 39 also has a collection hopper 24 which communicates with rotatable hopper arm 25. Said collection hopper 24 is slidably removable via rails (not shown) mounted on rotatable hopper arm 25.

Sweeping mechanism 39 further comprises a ramp subassembly 44. Ramp subassembly 44 comprises ramp 22, a chain 23, and ramp guides 45. Ramp 22 has a first end 22A communicating with mechanical sweeper frame 17, and a second end 22B communicating with ramp 22. Chain 23 has a first end 23A communicating with mechanical sweeper frame 17, and a second end 23B communicating with ramp second end 22B. Ramp first end 22A communicates with ramp guides 45 making device capable of raising or lowering ramp 22. Ramp guides 45 is a vertical support element fixing the position of the top of ramp 22A.

Sweeping mechanism 39 further comprises curtain 21 which communicates with mechanical sweeper frame 17.

Still referring to FIGS. 4 and 5, weight sensor 54 is attached to an end of spring 56. When weight sensor 54 detects a defined weight for a defined time, in the preferred embodiment, a decrease of approximately one eighth of one pound (approximately 57 grams) for approximately one minute, said weight sensor 54 provides a ninth signal to 47. Upon receipt of said ninth signal computer 47 will send a tenth signal light 48. Upon receipt of said tenth signal from computer 47, light 48 will illuminate.

Bottom end 20B of bristle height adjuster (jack screw) 20 is attached to spring 56 at one end, and spring 56 is attached to weight sensor (scale) 54. Weight sensor 54 is attached to the most elevated surface of bristle support arm 42 as illustrated in FIGS. 4 and 5. As bristles disintegrate with wear they shorten and lose contact with the surface of the ground. Such loss of contact results in the removal of upward force from ground to bristle support arm 42 adding strain to spring 56 which is detected by weight sensor 54. Weight sensor 54 is adapted to sending a signal to computer 47 when said weight increases by approximately one pound for one minute. Upon receipt of said signal computer 47 will signal light 48. Upon receipt of signal from computer 47, light 48 will illuminate.

Wear on drive wheels 16 is detected using a height sensor on drive wheel axle 53 is attached to the terminus of drive wheel axle 300. Said height sensor 53 is preferably an aftermarket ride-height sensor which electronically tracks distance between a vehicle's underside and the surface of the ground, said height sensor 53 being adapted to communicate with said computer 47. When drive wheel axle 300 drops approximately one inch closer to the surface for approximately one minute said height sensor 53 provides an eleventh signal to 47. Upon receipt of said eleventh signal computer 47 will send a twelfth signal to light 48. Upon receipt of said twelfth signal from computer 47, light 48 will illuminate.

Referring primarily to FIG. 1, FIG. 2, and FIG. 3, a cart-like structure contains four holes, two (2) holes on each side of vertical portions of the cart-like structure. Four (4) track rollers 6 are bolted to the four (4) holes to allow the entire cart to ride along support structure 38. A rigid rod is connected to the cart like structure to push and pull the cart along the linear guide rails, reachable from the edge of the support structure 38. The opposite side of the same steel rod contains a steel plate. The rigid plate fits between the two staggered slits on the linear rails, limiting the U-shaped cart structures movement. The top side of a solid surface rectangular turntable is bolted to the underside of the U-shaped cart structure. A rigid plate is bolted to the underside of the same solid surface rectangular turntable. A hitch receiver with multiple pin holes is welded to the plate to create a vertically oriented hitch receiver. Then a hitch shank can be locked into a variety of different locations. The hitch shank is connected to a mechanical or stationary mechanism that cleans debris off hard surfaces.

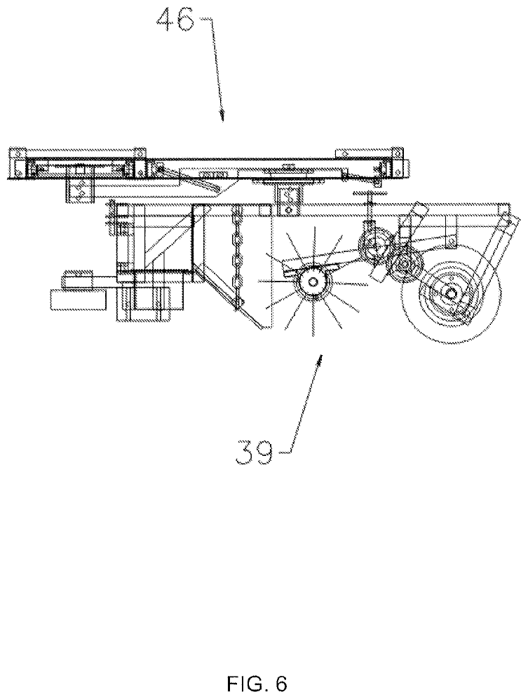

FIGS. 4, 5, and 6 are FIGS. 1, 2, and 3 when attached to an existing vehicle.

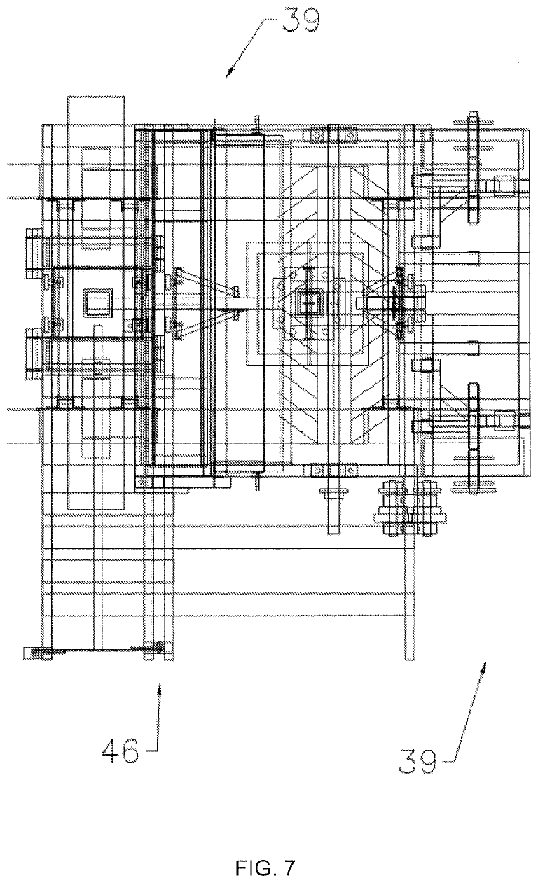

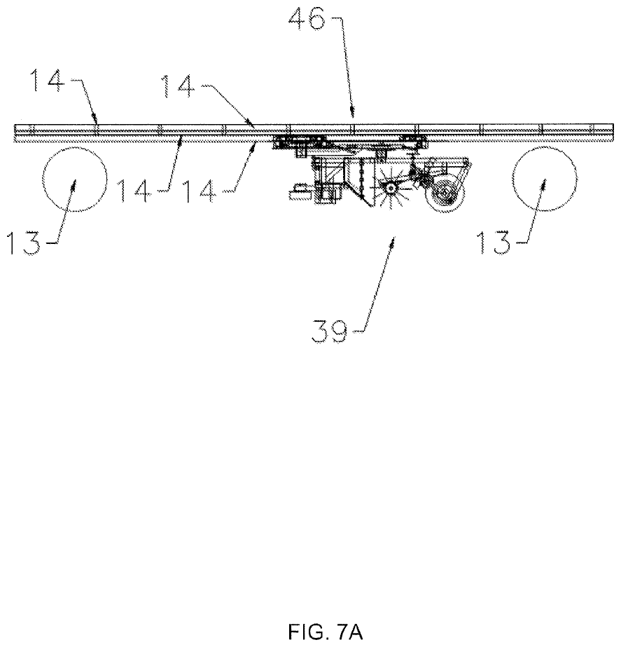

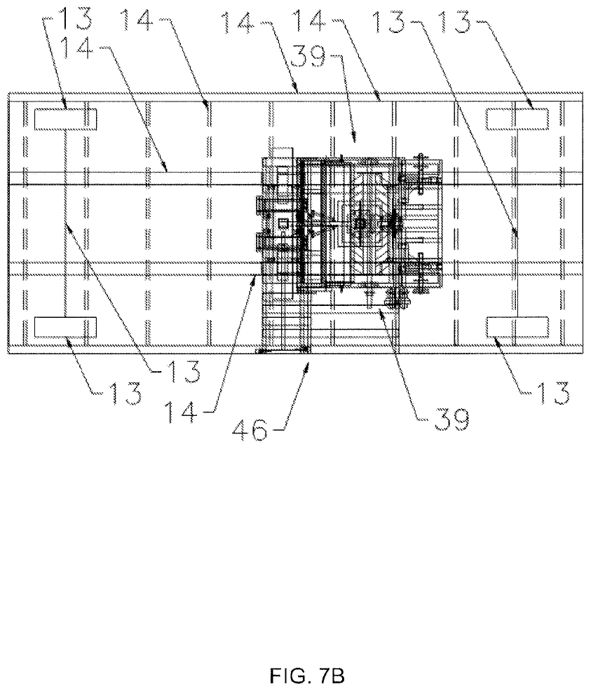

Referring to FIG. 7, a mechanical sweeping mechanism is used for the collection of debris. Movement of a pre-existing vehicle rotates the independently suspended drive wheels. A system of gears/pulleys and chain/belts transmits the rotation of the drive wheels to power a cylindrical bristle, spinning in the opposite direction of travel. The bristle's height can be adjusted accordingly. Debris that is swept with the bristle system is contained within the confines of the mechanical sweeper with side curtains that directs debris up a ramp and into a collection hopper. The collection hopper is removable and the structure upon which the collection hopper rests can be rotated outside the mechanical sweeper's frame. A magnet and skid plate are also attached the collection hopper's rotatable structure. A hitch shank is pinned to the center and top of the mechanical sweepers frame and fits into the hitch receiver of the U-shaped cart like structure, above, that rides along the support structure 38.

In a preferred embodiment, the rigid components are fabricated of steel or other durable metal.

In a preferred embodiment, at least two rigid rails are deployed in parallel are fabricated of steel or other durable metal.

Other embodiments not disclosed in detail include: (1) modifying the linear rails 1 by rotating one or more of the linear rail cross members 2 along the axis of the linear rails 1; (2) framing linear rails 1 to provide additional strength and avoid breakage to the connections with linear rail cross members 2; (3) adding fixture points for additionally moveable linear rail cross-members 2; (4) application of the current invention to non-GSE vehicles by modifying communication elements to affix to standard vehicular undercarriages; (5) replacing pin-communication between GSE element and the present invention with a spring or dynamically adjustable height mechanism to compensate for height of GSE.

### Full-Container Sensor Embodiment

Sensor specifications-infrared (IR) LED transmitter and a separate receiver. Both can be powered by 5V battery or from the I/O Expander DC output. The range is 1″ to 20″. The output signal from the receiver is connected to one input on the I/O Expander block. Said output block communicates Its output to the baggage cart driver by configuring with baggage cart driver.

More specifically, the present invention incorporates the same, an IR transmitter and IR receiver are commonly used to control electronic devices wirelessly. In the preferred embodiment the alert system consists of an IR receiver sensor that is used to receive an output signal from the IR based remote transmitter, a light visible to a baggage cart diver and. More particularly, a light visible to a baggage cart operator is illuminated when the signal from the remote IR transmitter to the IR remote receiver is terminated.

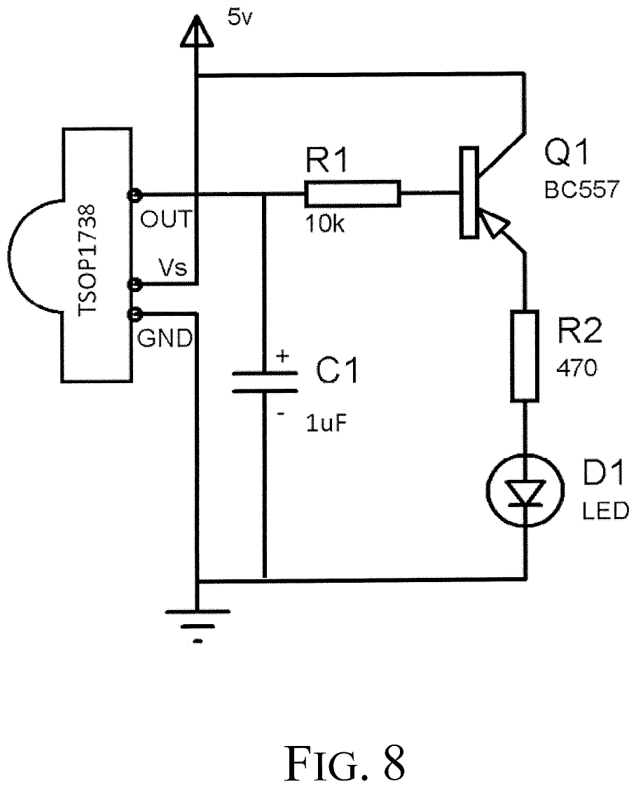

In the preferred embodiment said signal works on a frequency of 38 Khz. Additionally, the IR receiver includes a photodetector and preamplifier inside it (allowing the IR receiver to be a low power device that is highly immune to ambient light while enabled to senses modulated IR pulses and convert them into electrical signal. Said IR transmitter uses a LED which consumes 20 mA current and 3 volts of power. IR LEDs have light-emitting angle of approx. 20-60 degree and range of approx. six feet. Said IR receiver communicates (via electrical wire or by wireless means) to an LED light (visible to the baggage cart operator). Said light is power by a battery which powers the IR transmitter and IR receiver. A sample circuit wiring diagram for IR transmitter is depicted in FIG. 8 at the left and IR receiving circuit at the right.

Notes for circuits shown above: Thin small outline package (TSOP) is a type of surface mount IC package. They are very low-profile (about 1 mm) and have tight lead spacing (as low as 0.5 mm). Both circuits shown above are RC circuits which have a resistor (R) and a capacitor (C) connected in series with a power source. Transistors are identified in schematics with a reference designator (REFDES) starting with the letter “Q” and “D” is for diode. “B” is for circuit breaker. VCC (Voltage Common Collector) is the higher voltage with respect to GND (ground). VCC is the power input of a device. “DC” means direct current.

Referring still to FIGS. 4 and 5, an infrared transmitter 49 is attached to leading edge front corner of collection hopper 24 preferably about one inch (2.54 cm) below the top rim thereof. Infrared receiver 50 is attached in the diagonally opposed rear corner at approximately the same level relative to said rim. Infrared transmitter 49 emits a beam in accordance with the specification below. Infrared receiver 50 is adapted to communicate with computer 47. When said beam from IR transmitter 49 is disrupted, preferably for about ten seconds (to distinguish interruptions from height of FOD in collection hopper 24 from transitory introduction of FOD swept in), infrared receiver 50 signals computer 47. Upon receipt of said signal computer 47 will signal light 48. Upon receipt of signal from computer 47, light 48 will illuminate.

Embodiment with Suspension

Traditional GSE such as baggage carts do not contain any suspension systems—as end of lifecycles of these older carts approach, newer, more refined GSE baggage carts are emerging in the market. One major change in the newer carts is an integrated suspension system.

In older GSE carts without suspensions, clearance from ground to underside of cart was relatively steady; with only minimal differences from cart to cart, primarily due to cart tire pressures and/or manufacturers. Introducing suspension systems to carts will create variable ground clearances-both from uneven road surfaces and the loading/unloading of baggage weight.

To ensure mechanical (or non-mechanical) devices riding the underside of GSE baggage carts (or any existing vehicle) can remain at the same relative ride height, a suspension system can be added to the FOD removal device itself. The device's suspension system will allow the mechanical or non-mechanic device to properly operate with variable ground clearance.

One embodiment for a adjusting vertical suspension for a foreign object debris removal element to compensate for baggage cart height changes is a system comprising a foreign object debris removal element, spring means on said foreign object debris removal element (such as disclosed in U.S. Pat. No. 11,840,813, support means on said foreign object debris removal element connected to said spring means, wheels on said spring means, motion translating means connected to said support means and said spring means, power means and valve means to control motion of said motion translating means whereby upon said valve means being positioned to a desired foreign object debris removal element ground clearance, power is supplied to aid motion translating means through said valve means rotating said spring means to provide the desired ground clearance, said spring means comprising a torsion bar within a torsion tube disposed laterally and interiorly of said foreign object debris removal element, and a shock absorber disposed on the exterior of said vehicle, the same being connected to said torsion bar by means of an arm on said foreign object debris removal element wheels.

A typical adjusting vertical suspension is configured as disclosed in U.S. Pat. No. 3,371,940 (Mar. 5, 1968) for Vehicle Variable Height Suspension Systems by Alex H. Sinclair, et al. of Detroit, Mich.

### Leading and Trailing Camera Embodiment

As previously stated, foreign object debris (FOD) is detrimental to both aircraft and personnel. The majority of FOD generation occurs in areas of high ground movements. In this case, the tarmac areas surrounding aircraft gates. While the addition of newer FOD removal technologies improves the chance of FOD removal, redundancies and multiple systems operating in unison will create higher FOD removal success rates; particularly, non-human alert systems.

More specifically, new FOD technologies can assist in removal of FOD. In conjunction, and if and when these new removal technologies falter, backup systems can detect any missed debris not collected. The addition of continually scanning cameras and subsequent built-in alert systems for any missed debris by new FOD removal technologies can ensure the pickup of all FOD.

The image comparison software uses two offset cameras as imaging detecting systems. The processing is done using defined image comparison techniques. More specifically, a first camera 51 and second camera 52 acquire reference image data representing the first camera's 51 data to form a reference gradient image, of each pixel of which represents a value of a two-dimensional (2D) gradient of irradiance distribution associated with the reference sample. The software determines a reference edge image data representing a position of an edge associated with the first camera's 51 databased on the reference gradient image data. Subsequent, forming a reference binary image data by assigning a first value to first pixels of the reference gradient image data that correspond to the edge associated with the reference sample, and assigning a second value to the remaining pixels of the reference gradient image, the second value being different from the first value. Once said reference images are stored, reference binary image is created from the reference binary image data. Based on the comparison of pixelized data from the two cameras using a processing unit, the inverted reference binary image with the image of the second camera's 52 data to form a comparison image, said comparison image being devoid of an edge that is associated with both the first camera's 51 data and the first camera's 51 data.

Again referring to FIG. 5, first camera 51 is affixed to center of frame 17A. Second camera 52 is affixed to frame 17B. Both first camera 51 and second camera 52 are oriented to capture images of the ground surface passing beneath. Said first camera 51 and second camera 52 are communicated to computer 47 via integrated camera-image communication adapter (not shown). Said adapters may be wired or wireless. First camera 51 sends a sixth signal to computer 47; second camera 52 transmits a seventh signal to computer 47. Upon receipt of said sixth signal and said seventh signal, computer 47 is adapted to store and compare images in accordance with the method disclosed in this specification. When computer 47 software detects FOD, computer 47 sends an eights signal to indicator light 48 to illuminate.

### Brush-Replacement Indicator Embodiment

New FOD removal technologies without proper alert systems, particularly devices in hard to reach and mostly hidden areas, could pose FOD generation, rather than prevention. Additionally, new devices will need proper maintenance to operate and maintain strict FAA regulations. To help alleviate human interaction and errors, new FOD removal technologies need to be self-sufficient in terms of wear cycles and when specific components need replacement.

Specific to brushes, replacement brushes will be required as bristles wear over time. Instead of relying on human interaction, sensors and new technologies can help determine optimal replacement schedules.

### Wheel-Replacement Indicator Embodiment

New FOD removal technologies without proper alert systems, particularly devices in hard to reach and mostly hidden areas, could pose FOD generation, rather than prevention. Additionally, new devices will need proper maintenance to operate and maintain strict FAA regulations. To help alleviate human interaction and errors, new FOD removal technologies need to be self-sufficient in terms of wear cycles and when specific components need replacement.

Specific to wheels, replacement wheels will be required as rubber wears over time. Instead of relying on human interaction, sensors and new technologies can help determine optimal replacement schedules.

### Optimal Brush Height Embodiment

New FOD removal technologies without proper alert systems, particularly devices in hard to reach and mostly hidden areas, could pose FOD generation, rather than prevention. Additionally, new devices will need proper maintenance to operate and maintain strict FAA regulations. To help alleviate human interaction and errors, new FOD removal technologies need to be self-sufficient in terms of wear cycles.

In mechanical sweepers, brushes sweep FOD efficiently into collection bins. As the brush bristles wear, the entire brush height needs to lower to maintain proper bristle contact with the ground. With a brush assembly suspended, and lack of automatic lowering technologies, human interaction will be required to lower the brush height-potentially decreasing effectiveness of new FOD removal technologies. To ensure optimal efficiency and safety, sensors and automatic lowering devices can be added to the mechanical device. In combination with previously mentioned new detection technologies, a new generation of FOD removal devices can seamlessly transition into the FOD removal industry with little need of supervision and interaction by error prone humans.

### Alternate and Variant Embodiments

Various other modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate embodiments also can be implemented in combination in a single embodiment. Conversely, various features that are described in the context of a single embodiment also can be implemented in multiple embodiments separately or in any suitable sub-combination.

Moreover, although features may be described above as acting in certain combinations and even initially claimed as such, one or more features from a claimed combination can in some cases be excised from the combination, and the claimed combination may be directed to a sub-combination or variation of a sub-combination.

### INDUSTRIAL APPLICABILITY

The current invention is capable of exploitation in the airline industry most particularly, wherein FOD (foreign object debris) can be hazardous on aprons, hangars, ramps, runways, taxiways, and other airside surfaces or tarmac traversed by airplane tires. The application teaches a detachable apparatus which is at once convenient and economical in that it enhances the capabilities of existing GSE (ground support equipment) such as baggage-card transports by enabling them to remove FOD. Those skilled in the art will recognize the applicability of the current invention to other industries using, by way of example and not limitation, fork-lifts or golf carts, to promote safety.

### REFERENCE SIGNS LIST

1. Rail, preferably linear
2. Cross Members
3. L Brackets/Tabs
4. Plate Blockers
5. Cart Like Structure
6. Track Rollers
7. Rigid Rod
8. Rigid Plate
9. Turntable, including top element 9A and a bottom element 9B,
10. Rigid sheet
10A. Second rigid sheet
11. Hitch Receiver
11A. Second hitch receiver
12. NOT USED
13. Existing GSE wheel and axle
14. Existing Vehicle Structure (GSE Baggage Cart)
15. Suspension System/Shocks
16. Drive Wheels
17. Mechanical Sweeper Frame having a leading edge 17A and a trailing edge 17B,
18. Gear/Pulley System
19. Cylindrical Bristle Sweeper
20. Bristle Height Adjuster (jack screw) having a top end 20A and a
bottom end 20B
21. Curtain
22. Ramp
23. Chain
24. Collection Hopper
25. Rotatable Hopper Arm/Hinge
26. Magnet
27. Pinned Hitch Shank
28. Existing Vehicle Attachment (GSE Baggage Cart)
29. Existing Vehicle Attachment (GSE Baggage Cart)—Cross Member
30. NOT USED
31. Rigid tab support attachment
32. Female tab
33. Male
34. Skid-plate
35. Magnet Support
36. Spring Loaded Pin Hitch
37. Communication elements
38. Support structure
39. Sweeping mechanism
40. Total cart assembly
41. Trailing arm
42. Bristle support arm
43. Pivot joint
44. Ramp assembly
45. Ramp guides
46. An assembly of communication element 37, support structure 38, and total cart assembly 40
47, Computer
48. Light visible to GSE tug driver
49. Infrared transmitter in leading edge front corner of collection hopper 24
50. Infrared receiver in collection hopper
51. First camera
52. Second camera
53. Height sensor on drive wheel axle
54. Weight sensor on brush axle (bristle wear and brush height)
55. Variable height suspension (for total height assembly)
56 Spring communicating between top end 20A and bottom end 20B of bristle height adjuster 20
57-99 [reserved]
100. Trailing arm assembly
101. Spring attachment
102. Pivot shaft
103. Plate attached to turntable top element 9A, bottom element 9B, second rigid sheet 10A, and second hitch receiver 11A
104-199. [reserved]
200. Accelerometer on trailing arm
201. Communication accelerometer adapter
202. Communication height sensor adapter
203-299. [reserved]
300. Drive wheel axle

What is claimed is:

1. A removable sweeper assembly capable of attachment to ground support equipment for removing foreign object debris from a planar surface, comprising
a computer
a light,
wherein said computer is configured to communicate with said light; and
wherein said light is visible to a user of said ground support equipment;
at least one rigid rail,
wherein said computer is affixed to said at least one rigid rail;
at least three rigid rail cross-members,
wherein at least two rigid rail cross-members communicate with the top surface of said at said least two rigid rails.
at least two perpendicular rectangular rigid plate cross members,
at least two cart-like structure plate-blockers,
at least one communication element having a first end and a second end,
at least one cart-like structure,
at least one track roller,
wherein said at least one track roller is rideably connected to said at least one rigid rail,
at least one rigid rod,
at least one rigid plate,
at least one turntable, having a top element and a bottom element,
wherein said top element and said bottom element communicate by ball bearings disposed therebetween,
at least one rigid sheet,
at least one hitch receiver,
a sweeping mechanism,
at least one wheel,
at least one drive wheel axle,
a mechanical sweeper frame, having a first and a second end,
a gear/chain/belt assembly,
a cylindrical bristle sweeper,
a bristle height adjustment jack screw having a first end and a second end,
a curtain,
a ramp having a first end and a second end,
at least one ramp guide,
a chain having a first end and a second end,
a collection hopper,
a rotatable hopper arm,
a trailing arm having a first end and a second end,
a bristle support arm,
at least one magnet,
at least one magnet support,
at least one hitch shank,
at least one rigid tab support attachment,
at least one male tab and at least one female tab,
at least one shock absorber having a first end and a second end,
at least one skid plate,
at least one spring loaded pin hitch having a first end and a second end,
a pivot joint,
a communication element having a first end and a second end,
at least one support structure having a first end and a second end,
wherein a total cart subassembly comprises said at least one cart-like structure, said at least one track roller, said at least one rigid rod, said at least one rigid plate, said at least one turntable, said at least one rigid sheet, said at least one hitch receiver; and
wherein a sweeper subassembly comprises said at least one shock absorber, said at least one drive wheel, said mechanical sweeper frame, said at least one gear/chain/belt assembly, said cylindrical bristle sweeper, said bristle height adjustment jack screw, said curtain, said ramp, said chain, said collection hopper, said rotatable arm, said at least one magnet, said at least one magnet support, said at least one hitch shank, said at least one skid plate, said at least one spring loaded pin hitch, said trailing arm, said bristle support arm, said pivot joint, and said at least one ramp guide,

2. The removable sweeper assembly of claim 1, wherein said at least two rigid rails contain two slightly staggered slits, one on each of said at least two rigid rails.

3. The removable sweeper assembly of claim 1, further comprising a cart like structure; wherein said cart like structure with four holes disposed thereupon including: two (2) holes on each side of the vertical portions of said cart like structure; and four track rollers are bolted to said four holes such that said cart like structure communicates with said sweeper attachment.

4. The removable sweeper assembly of claim 1, wherein said at least two rigid linear rails communicate with at least two steel L-brackets, wherein said at least two steel L-brackets are welded to the tops of said at least at least three rigid rail cross-members; and wherein said at least two steel L-brackets communicate with said ground support equipment.

5. The removable sweeper assembly of claim 1, wherein said at least one cart-like structure may be comprised of a durable rigid linear cart-like structure.

6. The removable sweeper assembly of claim 1, wherein said pin connection is replaced by a dynamic spring connection.

7. The removable sweeper assembly of claim 1, wherein said at least one rigid rail is linear.

8. The removable sweeper assembly of claim 7, wherein said linear at least one rigid rail is parallel to a second rigid rail.

9. The removable sweeper assembly of claim 1, wherein said at least one rigid rail is fabricated of steel.

10. The removable sweeper assembly of claim 1, wherein said collection hopper further comprises:
an infrared transmitter,
an infrared receiver,
wherein said infrared transmitter and said infrared receiver are in communication with each other; and
wherein said infrared transmitter and said infrared receiver are disposed within approximately one inch below a rim of said collection hopper, and disposed; and
wherein said infrared transmitter is disposed at a leading internal corner of said collection hopper; and
wherein said infrared receiver is disposed at a trailing internal corner of said collection hopper most distant from said leading internal corner within line of sight of said infrared transmitter; and
wherein said infrared receiver is configured to communicate a first signal to said computer when said line of sight is disrupted for a defined period of time; and
whereupon receipt of said first signal said computer will communicate a second signal to said light causing said light to illuminate.

11. The removable sweeper assembly of claim 1, wherein said at least one cart-like structure further comprises:
a variable height suspension assembly, further comprising
a second rigid sheet
a second hitch receiver,
a trailing arm assembly,
at least one spring,
a pivot shaft,
a turntable plate,
an accelerometer on said trailing arm assembly, and
a communication accelerometer adapter;
wherein said accelerometer sends a third signal to said communication accelerometer adapter upon a defined acceleration, whereupon said communication accelerometer adapter sends a fourth signal to said computer, and
whereupon receipt of said fourth signal said computer initiates a fifth signal to said light causing said light to illuminate.

12. The removable sweeper assembly of claim 1, wherein said mechanical sweeper frame further comprises:
a first camera disposed upon said first end,
a second camera disposed upon said second end,
wherein said first camera and said second camera are oriented to collect images from the ground, and
said first camera is adapted to communicate a sixth signal containing said ground images to said computer, and
wherein said second camera is adapted to communicate a seventh signal containing said ground images to said computer, and
wherein said computer processes said images using a defined image comparison technique to identify said foreign object debris; and
whereupon when said foreign object debris is identified, said computer initiates an eighth signal to said light causing said light to illuminate.

13. The removable sweeper assembly of claim 1, wherein said bristle support arm further comprises:
a weight sensor attached to a most elevated surface of said bristle support arm,
a bristle height adjuster having a top end and a bottom end,
a spring having a first end and a second end,
wherein said first end of said spring is attached to said bottom end of said bristle height adjuster, and said second end of said spring is attached to said weight sensor; and
wherein said weight sensor is adapted to send a ninth signal to said computer upon detecting a defined decrease for a defined time period; and
whereupon said computer initiates a tenth signal to said light causing said light to illuminate.

14. The removable sweeper assembly of claim 1, further comprising
a height sensor attached to a terminus of said at least one drive wheel axle,
wherein said height sensor is adapted to send an eleventh signal to said computer upon detecting a defined reduction of said at least one drive wheel axle's distance from the ground,
whereupon said computer initiates a twelfth signal to said light causing said light to illuminate.
